(19) United States
(12) Patent Application Publication
(10) Pub. No.: US 2004/0078776 A1
(43) Pub. Date: Apr. 22, 2004

(54) System and method for browser-based arbitration in classification workflows

(76) Inventors: Charles Moon, Round Rock, TX (US); Vasken Torossian, Round Rock, TX (US); Eric Freeman, Austin, TX (US)

Correspondence Address: TAYLOR RUSSELL & RUSSELL, P.C., 4807 SPICEWOOD SPRINGS ROAD, BUILDING ONE, SUITE 1200, AUSTIN, TX, 78759, US

(21) Appl. No.: 10/653,689

(22) Filed: Sep. 2, 2003

Related U.S. Application Data
(60) Provisional application No. 60/407,744, filed on Sep. 3, 2002.

(51) Int. Cl. G06F 9/44

(52) U.S. Cl. 717/101; 717/105; 717/113

(57) ABSTRACT

A method for incorporating human arbitration into an otherwise automated workflow process for the purpose of classifying documents. Workflow management for document classification processes enables users to manage a process by arranging complex tasks into predefined sequences with decision points that steer tasks to completion. The method enables human arbitration of the workflow processes for document classification by providing a browser based user interface for arbitrating document classification processes. A software implemented system for browser-based arbitration in a classification workflow process comprising authenticating a user name and password for enabling a user logon, displaying a task list screen, the task list screen displaying a summary list containing each current task that the user has permission to view and links to a task detail screen, a search form screen, and a search queue screen, and enabling the user to arbitrate an assigned classification of assigned tasks in the workflow process.

This application claims benefit of U.S. Provisional Application No. 60/407,744, filed on Sep. 3, 2002.

### BACKGROUND

The invention relates generally to automated workflow processes for classifying documents, and more particularly to incorporating human arbitration into otherwise automated workflows aimed at classifying documents. Workflow management for document classification processes enables users to manage a process by arranging complex tasks into predefined sequences with decision points that steer tasks to completion. The invention enables human arbitration of the workflow processes for document classification by providing a browser based user interface having unique features for arbitrating document classification processes.

Document classification is a fundamental part of the operation of many enterprises. In many cases the success of the enterprise depends on its ability to accurately and efficiently process incoming documents. An example from the Insurance industry is the processing of claims forms. The advent of commercial data processing resulted in a movement to convert established paper-based document flows into automated workflows based on electronic documents. However, such efforts have often foundered due to the inability of the automated document processing facility to deal with incomplete or flawed data and its inability to apply human judgment at critical decision points to handle exceptions and resolve ambiguities.

The System and Method for Classification of Documents disclosed in U.S. patent application Ser. No. 10/248,962 describes a workflow management system for document classification based on similarity search technology described in U.S. patent application Ser. No. 10/365,828. Although an embodiment of the current invention was first implemented as part of an application for dealing with insurance claims, the invention described herein is applicable for use with any document classification applications that call for human arbitration at decision points of the workflow.

For small-scale workflows, ad hoc arbitration may be able to handle occasional exceptions that occur during normal operations. However, as the scale of operations increases, it becomes important to effectively manage the arbitration process. The requirements for an enterprise-level workflow management system for document classification include the following capabilities:

documenting arbitration decisions;

human inspection and confirmation of document classifications;

obtaining missing data, adding it to documents, and returning them to the automated flow;

performing off-line analyses based on information in the documents and including those results as additional decision factors;

overriding classification decisions made by automated decision points; and

management of the arbitration task that efficiently spreads the workload among the team of arbitrators and allows supervisory tracking of assignments.

Furthermore, integration of human arbitration into the otherwise automated workflow should not impede the automated flow of work. The arbitration user interface must be secure and accessible across the enterprise.

An example application of an arbitration method to insurance claims processing would be as a follow up to the initial screening of claims submitted for payment. An automated classification system may be deployed to identify claims eligible for immediate payment and to pass others on for investigation. At this point in the workflow, there may be a class of claims with missing data that prevents them from being classified as worthy for payment at a high enough level of certainty to warrant immediate payment, yet on the other hand they also lack the tell-tale signs of possible fraud that would warrant them being passed to a Special Investigations Unit. At this point in the workflow it would be beneficial to have the unclassified claims examined by a human auditor, who may be able to immediately ascertain the correct disposition, or who may go on to conduct additional searches either to verify the data on the claim or to fill in missing data that prevented the automated classification system from reaching a result.

### SUMMARY

It is objects of the present invention to satisfy these needs. The invention comprises an arbitration user interface that provides access to a document database and a classification engine. The classification engine may receive data from various sources such as a similarity search engine, neural network, rules engine, or other analytics. The invention enables a user to access information and initiate a classification function when automated processes have foundered due to the inability to deal with incomplete or flawed data and its inability to apply human judgment at critical decision points to handle exceptions and resolve ambiguities.

The processing of an arbitration request by a user begins with the generation of an HTML request in response to user inputs through a browser user interface. An error handler set up to deal with uncaught exceptions processes the request. In the normal non-error flow, the request passes through a security filter that verifies that the user is properly authenticated. The request then passes through a logging filter so that a persistent record of the request is made. Once the request has been authenticated and logged, it passed to a request mapper, which invokes the appropriate request handler to carry out the requested action. A doAction( ) method is used to route the request to the appropriate action handlers, drawing on DataBeans (data) and FormBeans (input forms), as well as entities in a similarity Search Engine (SSE) Object layer that perform searches and invoke external analytics. Action handlers include a login handler, a logout handler, a task handler, a detail handler, a task update handler, a search form handler, a search handler, a document detail handler, a side-by-side handler, a query queue handler, a query queue detail handler, and a note form handler. When the action handlers complete their operations, the request handler invokes the response builder to create the response to the request. The response builder also has access to the FormBeans, as well as the message catalog and configuration files. A response is written to a page content model, which invokes the render filter to format the return HTML. For this operation, XSL templates for XHTML, Excel, or PDF renderings maybe used. The result takes the same path to client as the incoming request, except in reverse order: the response is logged, authenticated, error-checked and finally transmitted back the user's browser via HTTP.

An embodiment of the present invention is a software implemented method in a computer system for browser-based arbitration in a classification workflow process, the method comprising the steps of authenticating a user name and password for enabling a user logon, displaying a task list screen, the task list screen displaying a summary list containing each current task that the user has permission to view and links to a task detail screen, a search form screen, and a search queue screen, and enabling the user to arbitrate an assigned classification of assigned tasks in the workflow process. The method may further comprise the step of allowing the user to update a class, status and ownership of tasks selected from the summary list of each current task. The step of displaying the summary list of each current task may include the steps of displaying a link to a task details screen, displaying a means for selecting the record, displaying a source document identification, displaying a task owner username, displaying created time and date, displaying a modified time and data, displaying a task class, displaying a task status, and displaying a justification summary for a classification. The method may further comprise the step of linking to the task detail screen for displaying detailed information about the results of a task including the steps of displaying summary information, a task history/log, a summary of rule checks that were applied to a source document, and a summary of queries. The step of displaying summary information may include the steps of displaying a source document identification, displaying a link to source document details screen, displaying a task owner username, displaying created time and date, displaying a modified time and data, displaying a current task class, displaying a current task status displaying a justification summary for a classification, and displaying means for enabling the user to update the task summary, the classification, and the owner. The step of displaying a task/history log may include the steps of displaying summary information from each entry in a task history and each note associated with the task, displaying a button for enabling the user to create a new note, displaying a date when a history record and each note was created, and displaying a contents of a description field for a history record and each note. The step of displaying a summary of rule checks that were applied to a source document may includes the steps of displaying a class for each rule, displaying a description of each rule that was applied to the class, displaying the target schema that was used in each rule check, displaying a highest score from each rule check, and displaying a link to a details screen for each rule check. The step of displaying a summary of queries may include the steps of displaying a name of a target schema, displaying the name of a field mapping that was used to map an input schema to a target schema, displaying a highest score returned, displaying the number of documents that were returned, and displaying a link to a side-by-side screen for displaying details of a query criteria and result. The method may further comprise the step of linking to the search form screen for enabling the user to define a query document and execute searches using available search engine schemas, comprising the steps of displaying text fields of a query document that match fields in a target schema for entering query data, displaying one or more target schemas and means for selecting one or more target schemas to search against, providing means for enabling the user to select immediate execution of a search and displaying a search results summary screen, and providing means for enabling a user to select a search in background execution by sending the search criteria to a queue for later execution and displaying the task list screen. The method may further comprise the steps of displaying two text fields for enabling a user to enter a range of document indexes for restricting a result set, displaying a means for selecting specific displayed schemas applicable to restricting a result set to a specific schema index ranges, displaying two text fields for enabling a user to enter a range of document scores for restricting a result set, and displaying a means for selecting specific displayed schemas applicable to restricting a result set to a specific score range. The method may further comprise the step of linking to the search queue screen for displaying status and results of background searches having delayed execution, comprising the steps of displaying a list of all searches queued by the user, for each queued search, displaying means for selecting the queued search, for each queued search, displaying a time/date that the search was queued and a time/date that the search was completed, and for each queued search, displaying target schemas that were searched, a number of returned result documents, and a current status of the queued searches. The method may further comprise for each queued search, the step of displaying a link to a search results summary screen if a search is completed. The method may further comprise the step of displaying a means for deleting selected queued searches. The method may further comprise the step of linking to the search result summary screen for reviewing a result from a specific search, comprising the steps of displaying a field name and criteria value for each populated field in an original query document, displaying summary search results for each returned document in a result set, including means for selecting a one or more result sets, result document identification for linking to a document detail search result screen, and result set score, displaying a header label indicating a target schema and mapping used to generate a query, displaying means for linking to a side-by-side search result screen and linking to a document detail search result screen, and displaying means for selecting all documents in a result set and for clearing all documents in a result set. The method may further comprise the step of linking to the side-by-side search result screen for enabling the user to view details for multiple documents, comprising the steps of displaying query document data including field name, criteria value and score, displaying side-by-side search results by column for each result set, including a document identification, overall document score, and target schema that contains the document, and displaying a field name for each mapped node in a target schema, a target value for that node, and a score for that node. The method may further comprise the step of linking to the document detail search result screen for enabling the user to view results of a single document, comprising the steps of displaying a document identification, a document's schema name, and a link to open the document in a fraud investigator application, and displaying each field name and field value of the result document. The method may further comprise the steps of enabling the user to attach a note to a task record, and enabling the user to obtain help information online. The invention includes a computer-readable medium containing instructions for controlling a computer system according to the method described.

Another embodiment of the present invention is a user interface method for browser-based arbitration in a classification workflow process, the method comprising entering a user name and password for enabling user authentication, viewing a task list screen, the task list screen displaying a summary list containing each current task that the user has permission to view and links to a task detail screen, a search form screen, and a search queue screen, and arbitrating an assigned classification of assigned tasks in the workflow process. The method may further comprise updating a class, status and ownership of tasks selected from the summary list of each current task. The method may further comprise viewing the summary list of each current task, including viewing a link to a task details screen, viewing a means for selecting the record, viewing a source document identification, viewing a task owner username, viewing created time and date, viewing a modified time and data, viewing a task class, viewing a task status, and viewing a justification summary for a classification. The method may further comprise selecting the task detail screen for viewing detailed information about the results of a task including viewing summary information, a task history/log, a summary of rule checks that were applied to a source document, and a summary of queries. The method, wherein viewing summary information may include viewing a source document identification, viewing a link to source document details screen, viewing a task owner username, viewing created time and date, viewing a modified time and data, viewing a current task class, viewing a current task status, viewing a justification summary for a classification, and viewing means for enabling the user to update the task summary, the classification, and the owner. The method, wherein viewing a task/history log may include viewing summary information from each entry in a task history and each note associated with the task, viewing a button for enabling the user to create a new note, viewing a date when a history record and each note was created, and viewing a contents of a description field for a history record and each note. The method, wherein viewing a summary of rule checks that were applied to a source document may include viewing a class for each rule, viewing a description of each rule that was applied to the class, viewing the target schema that was used in each rule check, viewing a highest score from each rule check, and viewing a link to a details screen for each rule check. The method, wherein viewing a summary of queries may include viewing a name of a target schema, viewing the name of a field mapping that was used to map an input schema to a target schema, viewing a highest score returned, viewing the number of documents that were returned, and viewing a link to a side-by-side screen for displaying details of a query criteria and result. The method may further comprise selecting a link to the search form screen for enabling the user to define a query document and execute searches using available search engine schemas, comprising viewing text fields of a query document that match fields in a target schema for entering query data, viewing one or more target schemas and means for selecting one or more target schemas to search against, selecting immediate execution of a search and viewing a search results summary screen, and selecting a search in background execution for sending the search criteria to a queue for later execution and viewing the task list screen. The method may further comprise entering a range of document indexes into two text fields for restricting a result set, selecting specific displayed schemas applicable to restricting a result set to a specific schema index ranges, entering a range of document scores into two text fields for restricting a result set, and selecting specific displayed schemas applicable to restricting a result set to a specific score range. The method may further comprise selecting a link to the search queue screen for viewing status and results of background searches having delayed execution, comprising viewing a list of all searches queued by the user, for each queued search, selecting one or more queued searches, for each queued search, viewing a time/date that the search was queued and a time/date that the search was completed, and for each queued search, viewing target schemas that were searched, a number of returned result documents, and a current status of the queued searches. The method may further comprise for each queued search, viewing a link to a search results summary screen if a search is completed. The method may further comprise viewing a means for deleting selected queued searches. The method may further comprise selecting the link to the search result summary screen for reviewing a result from a specific search, comprising the steps of viewing a field name and criteria value for each populated field in an original query document, viewing summary search results for each returned document in a result set, including selecting a one or more result sets, result document identification for linking to a document detail search result screen, and result set score, viewing a header label indicating a target schema and mapping used to generate a query, linking to a side-by-side search result screen and linking to a document detail search result screen, and selecting all documents in a result set and for clearing all documents in a result set. The method may further comprise selecting the link to the side-by-side search result screen for enabling the user to view details fo multiple documents, comprising viewing query document data including field name, criteria value and score, viewing side-by-side search results by column for each result set, including a document identification, overall document score, and target schema that contains the document, and viewing a field name for each mapped node in a target schema, a target value for that node, and a score for that node. The method may further comprise selecting the link to the document detail search result screen for enabling the user to view results of a single document, comprising viewing a document identification, a document's schema name, and a link to open the document in a fraud investigator application, and viewing each field name and field value of the result document. The method may further comprise the steps of attaching a note to a task record, and obtaining help information online. The invention includes a computer-readable medium containing instructions for controlling a computer system according to the method described above.

Yet another embodiment of the present invention is a computer system for browser-based arbitration in a classification workflow process, comprising means for displaying workflow classification information, means for initiating a search based on selected task information, means for receiving task results from a classification engine, and means for interactively classifying task results. The system, wherein the means for displaying and receiving may be a computer display terminal, and the means for initiating and interactively classifying may be a computer keyboard and mouse.

Another embodiment of the present invention is a method in a computer system for browser-based arbitration in a classification workflow process, comprising a user for entering, selecting, viewing and updating classification task information in the computer system, and a computer display terminal, keyboard and mouse, and computer for displaying, enabling, linking, and providing classification task information to the user.

### BRIEF DESCRIPTION OF THE DRAWINGS

These and other features, aspects and advantages of the present invention will become better understood with regard to the following description, appended claims, and accompanying drawings wherein:

FIG. 1A shows an exemplary embodiment of the present invention in relation to a workflow and classification engine;

FIG. 1B shows a block diagram of the elements of the present invention;

FIG. 2 shows a login screen to enable user access to the system;

FIG. 3 shows a screenshot depicting a home page of the arbitration application that includes a listing of current tasks;

FIG. 4 shows a screenshot that enables a user to view detailed information associated with a task;

FIG. 5 shows a screenshot for enabling a user to define and execute searches using available search engine schemas;

FIG. 6 shows a screenshot that allows a user to view status and results of searches having delayed execution;

FIG. 7 shows a screen shot that provides a user with a summary view of a result from a specific search;

FIG. 8 shows a screenshot that allows a user to view details of multiple documents in a side-by-side fashion;

FIG. 9 shows a screenshot that allows a user to view details of a single document;

FIG. 10 shows a screenshot that enables a user to attach a note to a task record;

FIG. 11 shows a screenshot for enabling a user to view help information online; and

FIG. 12 shows a functional framework diagram of the components of the present invention.

FIG. 13 shows request handling flow diagram according to the present invention.

### DETAILED DESCRIPTION OF THE DRAWINGS

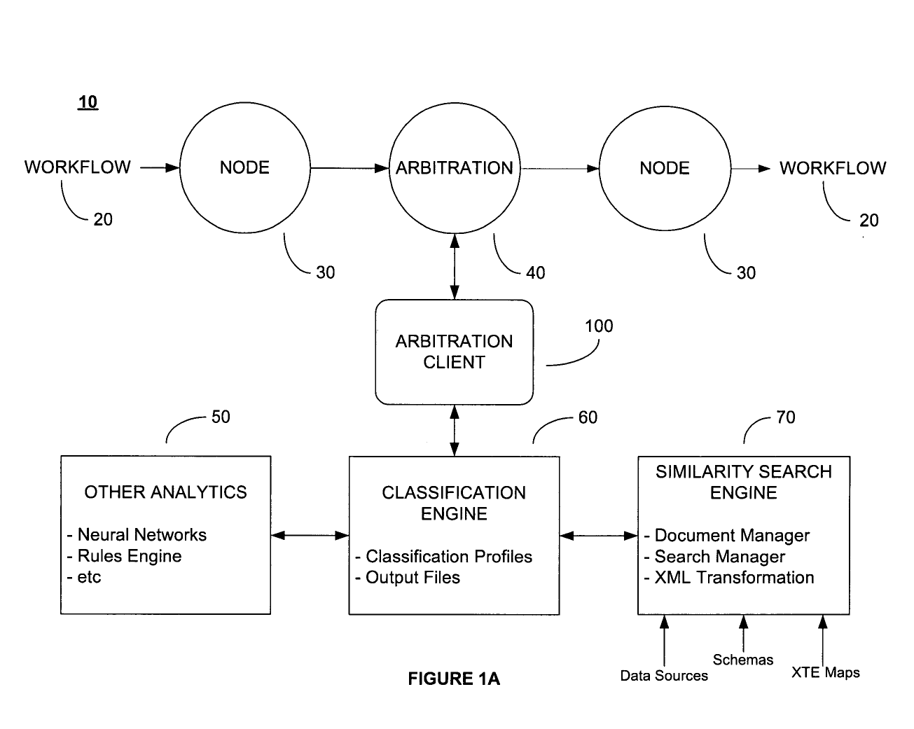

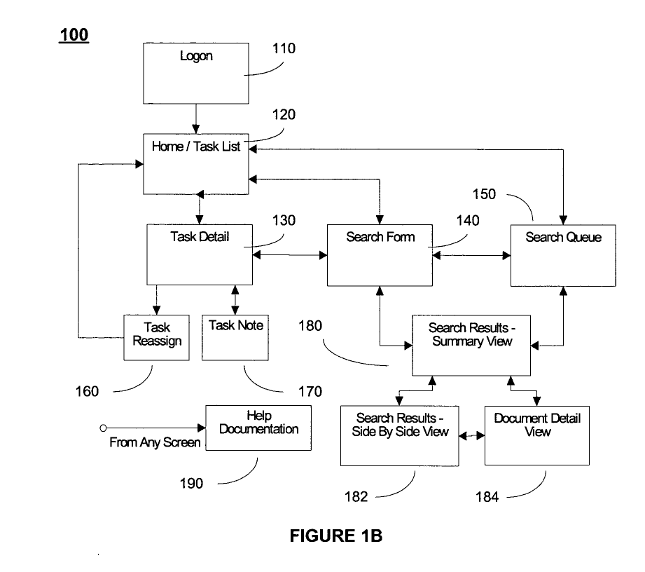

Turning to FIG. 1A, FIG. 1A shows an exemplary embodiment of the present invention in relation to a workflow and classification engine 10. As shown in the example 10, workflow 20 is processed by nodes 30, 40 in the workflow 20. An arbitration node 40 communicates with an arbitration client 100, which is the subject of the present disclosure. The arbitration client 100 communicates with a classification engine 60, which may interface with a similarity search engine 70 or other analytics 50.

Turning now to FIG. 1B, FIG. 1B shows a block diagram 100 of the elements of the present invention. The block diagram 100 depicts paths that an end user request follows through an application according to the present invention. After Logon 110, a Home/Task List screen 120 displays task list information. A Task Detail screen 130 provides a user with more detailed information. A Search Form screen 140 enable a user to define and perform similarity searches documents. A Search Queue screen 150 displays delayed search results, and a Search Result Summary screen 180 provides a summary view of a result from a specific search. A Side-by-Side Search Results screen 182 shows details of multiple documents in a side-by-side fashion, while a Document Detail screen 184 displays details of a single document. A Note screen 170 enables a user to attach a note to a task record, and a Help screen 190 enables a user to view help information online. A Reassign function 160 is part of the Home/Task List screen 130 and enables a user with proper authorization to reassign tasks between users.

Action handlers are a series of servlet-like classes that process an incoming user request and return the request/response along with a data object, either a JavaBean or an XML document, depending on the implementation. The request/response and data are then handed to a response generator class to build the appropriate user interface screen. Handler classes are summarized in relation to an associated screenshot below, which includes the type of object they return. The mapping of request URL's to ActionHandlers, and mapping of one or more ResponseBuilders to the ActionHandlers, is defined in a requestmapping.xml file, and handled by the RequestControllerServlet. Each ActionHandler will return at least the following objects by setting as attributes on the Request object, in addition to a result code [String], and a collection [ArrayList] of 0 or more Error Messages to display to the user. Response Handlers will always return an error message collection, even if it is empty.

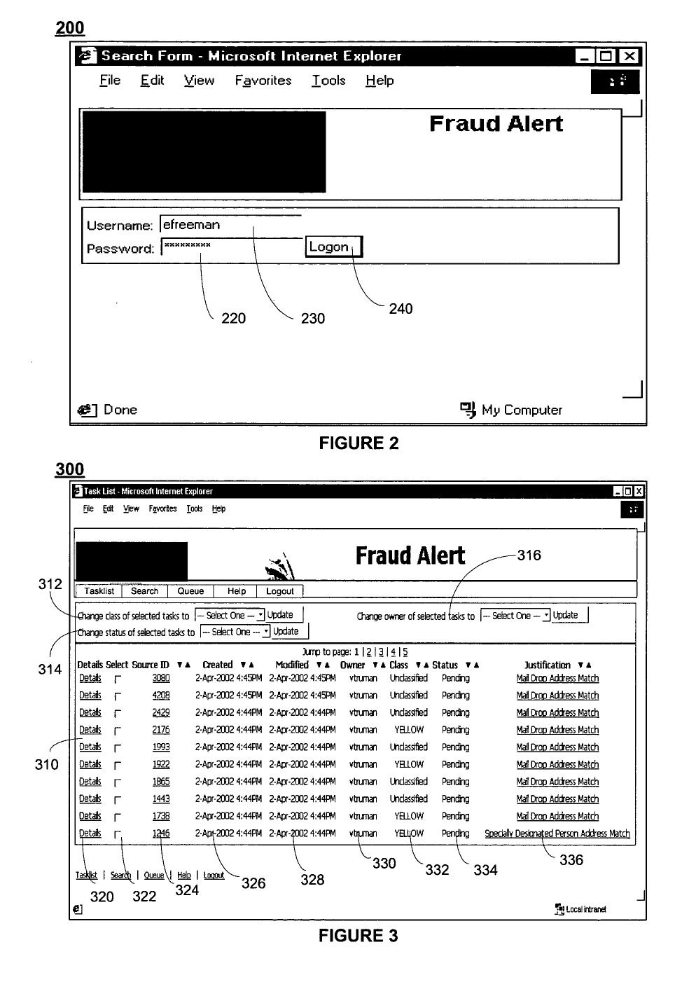

Turning to FIG. 2, FIG. 2 shows a login screen 200 to enable user access to the system. Access id achieved by entering a valid username 230 and password 220, and selecting the Logon button 240. Upon depressing the Logon button 240, the logon is processed by the LogonHandler. If the system is able to authenticate the user, the user is forwarded to the Home/Task List screen shown in FIG. 3 and a ConnectionBean is created for the session. Otherwise, the user is returned to the Logon screen 200 where an error message is displayed. Usernames and passwords are shared with the SSE. A LogoutHandler processes a user's logout request by deleting the user's ConnectionBean from the session.

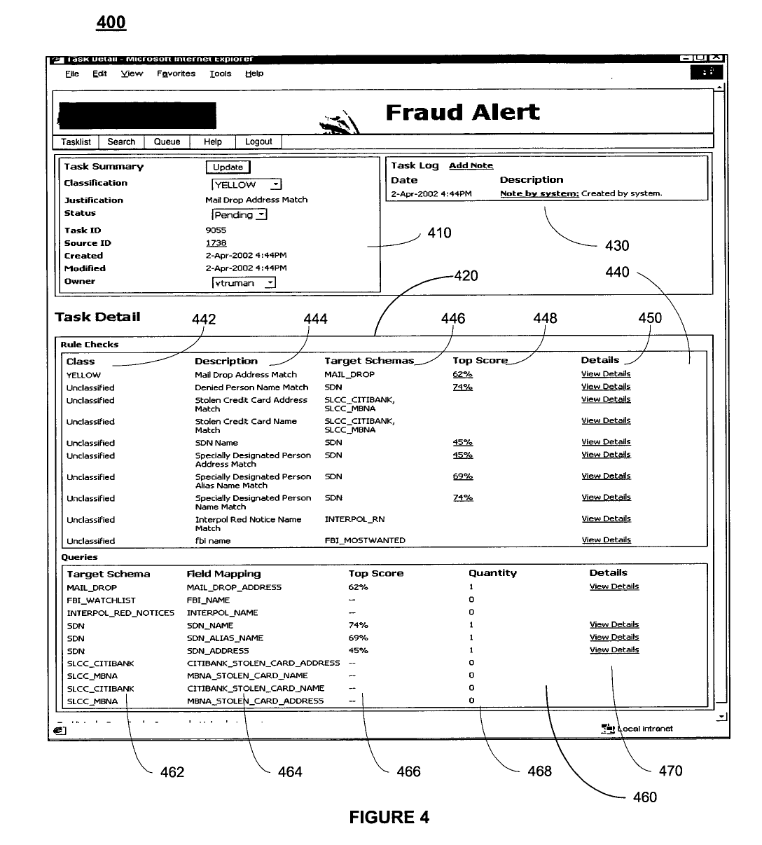

Turning to FIG. 3, FIG. 3 shows a screenshot 300 depicting a home page of the arbitration application that includes a listing of current tasks. The screenshot 300 enables a user to quickly update the status and or ownership of a given task. The user is able to quickly navigate from this summary list to any other portion of the application. The tasks displayed are filtered by owner username to only those tasks the user has permissions to view. The number of tasks displayed and the default sorting is selectable by a user. This screen may display a summary table of all task items 310 visible to the user's account. The mapping of which transactions are visible to which users/roles is determined by the Task List class and the underlying configuration files. The table shall display the following summary information for each task: a Details hyperlink 320 to a Task Detail Screen; a checkbox control 322 for selecting the record; source document Id # 324; task Owner username 330; task Created date/time 326; task Modified date/time 328; task Status 334; task Class 332; and summary Justification for the classification 336. The table is sortable by each of its columns, where the default sorting of the table is in reverse chronological order. An up or down arrow icon is displayed next to the column heading for the currently sorted column. At the top of the table is a drop down control with a list of owners and roles for updating the owner of the task 316. Also at the top of the table is a drop-down control with a list of statuses 314. If the user has sufficient permissions to view the task list of other users, the screen will also display a drop-down control with a list of all the usernames that the current user is permitted to view. The ability to change a class of a selected task is also provided 312. A user is able to view the details of a task record by clicking on the task id number or “Details” button link to access the Task Detail screen for that task, as shown in FIG. 4. A TaskListHandler retrieves the user's active tasks by returning a collection of task objects.

Turning to FIG. 4, FIG. 4 shows a screenshot 400 that enables a user to view detailed information associated with a task. The screenshot 400 displays detailed information about the results of a task, including the details of the classification process and update history. As shown in FIG. 4, the screenshot displays the following sections: a task summary 410, a task history/log 430, and a classification detail 420. The task summary section 410 displays summary information about the task, including an “Update” button to commit changes in the status or ownership of the task, the task's current class (red, yellow, green, etc.), a summary description of the justification for this classification, the task's current status (open, closed, etc.), including a drop-down control so that the user may update the status, the task identification, the source document identification, a hyperlink to view the source document details, the time and date that the task record was created, the time and date that the task record was updated, and the username of the task's owner. If the user has sufficient permissions to reassign a task, the owner field is displayed as a drop-down control. The task history/log 430 displays a table of summary information from each entry in the task history and each note associated with the task. Each row in the task history table 430 displays the following information: a button to allow the user to create a new note, the date the history record/note was created, and the contents of the description field for the history record/note. The classification detail section 440 displays results of the task after processing by the Classification Engine. The information in the classification detail section 420 includes a summary view of the queries 460 that were executed by the Classification Engine and a summary view of the rule checks 440 that were applied to the source document and the class they returned. As shown in FIG. 4, the summary view of the queries 460 includes the name of the target schema that was searched 462, the name of the field mapping that was used to map the input schema to the target schema 464, the highest score that was returned 466, the number of documents that was returned and stored 468, and a link to the details 470 of the query criteria and results in a side-by-side screen. The summary view of the rule checks 440 that were applied to the source document and the class they returned include the description of the rule 444 that was applied, the overall class 442 that was returned for this rule check, the target schemas 446 that were used in this rule check, the highest score 448 used in this rule check, and a link to view the details 450 of the rule check in a separate window. If a user has sufficient privileges, the user is able to update the ownership of the task by selecting a username and pressing an “Update” button. With sufficient privileges, the user is also able to update the status of the task by selecting a new status value and pressing the “Update” button. The user is able to add a new note to the task by pressing an “Add Note” button and filling out the information on a new note screen. The user may also refine a search by going to search definition screen, and the system will pre-populate the search form with the appropriate values from the original input document. A TaskDetailHandler and a TaskUpdateHandler support the screenshot shown in FIG. 4.

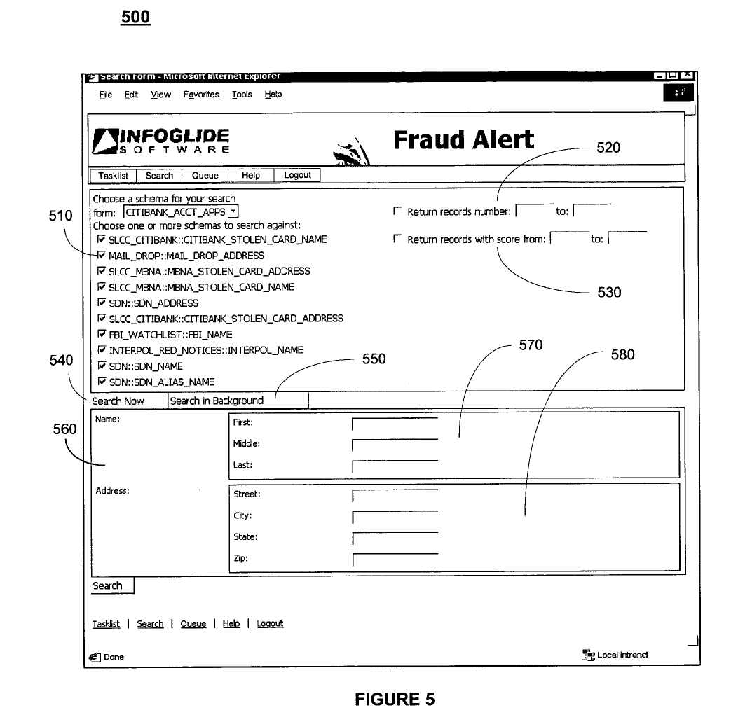

Turning to FIG. 5, FIG. 5 shows a screenshot 500 for enabling a user to define and execute searches using available search engine schemas. The screenshot 500 displays the screen specific buttons “Search Now” 540 and “Search in Background” 550. The structure of the search screen 500 is defined by elements of the default classification profile defined in this instance. An input schema defines the input form, and the available target schemas are defined by the set of target schema/xte mapping combinations. The screenshot 500 displays a search form whose fields and structure are defined by the input schema of the default classification profile. Only those fields in the input schema that are explicitly mapped to a field in one or more of the target schemas are displayed. If a field in the input schema is not explicitly mapped to a field in any of the target schemas, then that field will not be displayed in the search form. The search form provides entries for a query document 560. In the present example, the query document 560 comprises entry fields for designating Name 560 and Address 570. The screenshot 500 displays a set of checkboxes 510 to allow the user to select one or more target schemas/xte mapping combinations to search against. The set of checkboxes for available targets are defined by the unique set of target schemas/xte mapping combinations that are defined in the default classification profile. By default, all of the target schemas are selected. The screenshot 500 displays two text fields to allow a user to input a range of document indexes to restrict the result set 520. The screenshot also displays a checkbox adjacent to the fields 520 for all users to choose whether to apply the index restriction 520. The screenshot 500 also displays two text fields to allow the user to input a range of document scores to restrict the result set 530. The screenshot 500 also displays a checkbox adjacent to the fields 530 for all users to choose whether to apply the score restriction 530. The screenshot 500 also displays a drop-down list with the descriptions of each of the defined classification profiles in the similarity Search Engine. If a user presses the “Search in Background” button 550, the system sends the search criteria to a queue for later execution. The user will then be forwarded to the Task List screen shown in FIG. 3. If the user presses the “Search Now” button 540, the system will execute the search immediately. Once the search is completed, the user is forwarded to the Search Results screen shown in FIG. 7. For each target schema/xte mapping combination that is selected when executing a search, the application will (a) translate the input structure and criteria into the target schema using the selected xte mapping, (b) execute a search against the selected target schema, and (c) return a set of search results if any were found. If a user does not enter a value for the index restriction 520, the result set is limited to a size of 500. If a user enters a value for the index restriction and selects the checkbox adjacent to it 520, then the result set will contain only the specified entries in the result set. If a user enters a value for the score restriction and selects the checkbox adjacent to it 530, then the result set shall be restricted to those documents whose score falls within the specified range. Valid entries for the index restriction are all positive integers, where the end restriction is higher than the begin restriction. Valid entries for the score restriction are all positive numbers between 0.0 and 1.0. Invalid entries for either restriction field 520, 530 causes an error message to appear if the user attempts to execute the search, and prevent the search from executing. The SearchFormHandler supports the screenshot shown in FIG. 5.

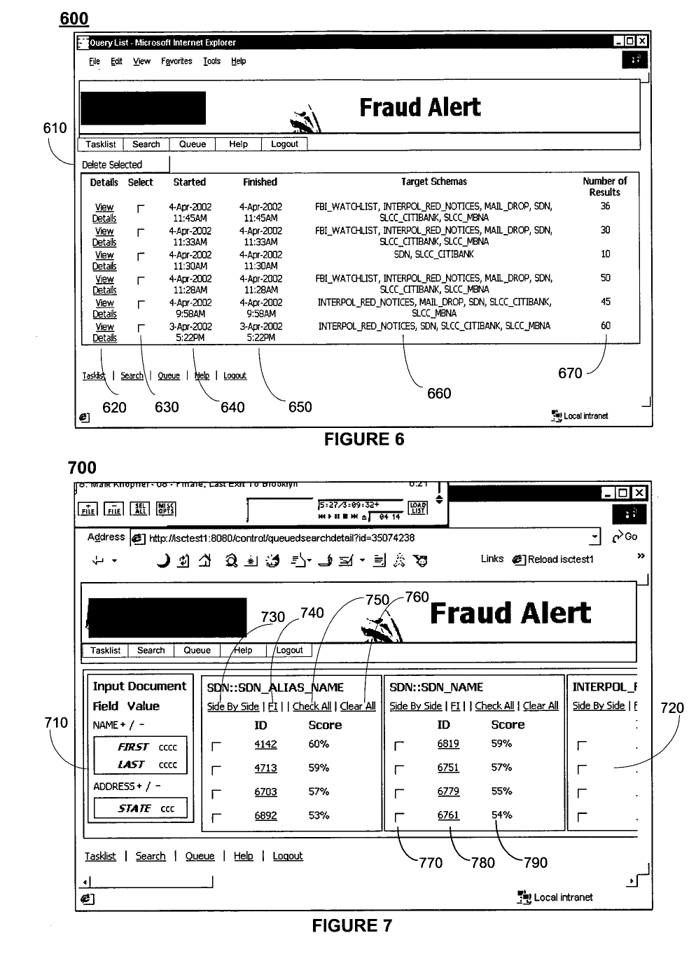

Turning to FIG. 6, FIG. 6 shows a screenshot 600 that allows a user to view status and results of searches having delayed execution. The screenshot 600 displays a table that lists all of the searches queued by the current user. The table displays the following for items for each queued search: a check box to select the queued search 630, a time/date that the search was queued 640, a time/date that the search was completed 650, target schemas that were being searched 660, the number of result documents that were returned 670, and the current status of the queued searches. If a search is completed, a link is displayed for going to the Search Results screen shown in FIG. 7. The screen also displays a “Delete Selected ”button 610. The user is able to select one or more searches and clear them from the queue by pressing the “Delete Selected” button 610. The user is also able to view the results of the queued search by following the link from the search's completed status label. The QueryQueueHandler and the QueryQueueDetailHandler support the screenshot shown in FIG. 6.

Turning to FIG. 7, FIG. 7 shows a screen shot 700 that provides a user with a summary view of a result from a specific search. The screenshot 700 displays two main sections, an original criteria for the search 710 and a summary table of search results 720 from each query that was executed. The query document section 710 displays the field name, and criteria value for each populated field in the original query document. Unpopulated fields may be hidden. The results for each query are displayed in a separate summary table 720 having a header label indicating the target schema and mapping used to generate the query. The summary table 720 displays the following links in it's header: Side by Side 730 opens the selected documents in a side-by-side view with the translated criteria used to generate that result set; FI 740 opens an entire result set in an investigative analysis application Fraud Investigator; Check All 750 selects all documents in the result set; and Clear All 760 deselects all documents in the result set. The summary table of search results 720 displays a row for each returned document in the result set. Each row displays the following items in columnar fashion: a checkbox 770 to select the given document, the document Identification 780 linked to the document detail view for this document, and the document's score 790. The summary table of search results 720 is not paginated. The user is able to select one or more documents from the results table and navigate to a side-by-side view by pressing the “Side-by-Side” button 730 next to selected documents. The SearchHandler supports the screenshot shown in FIG. 7.

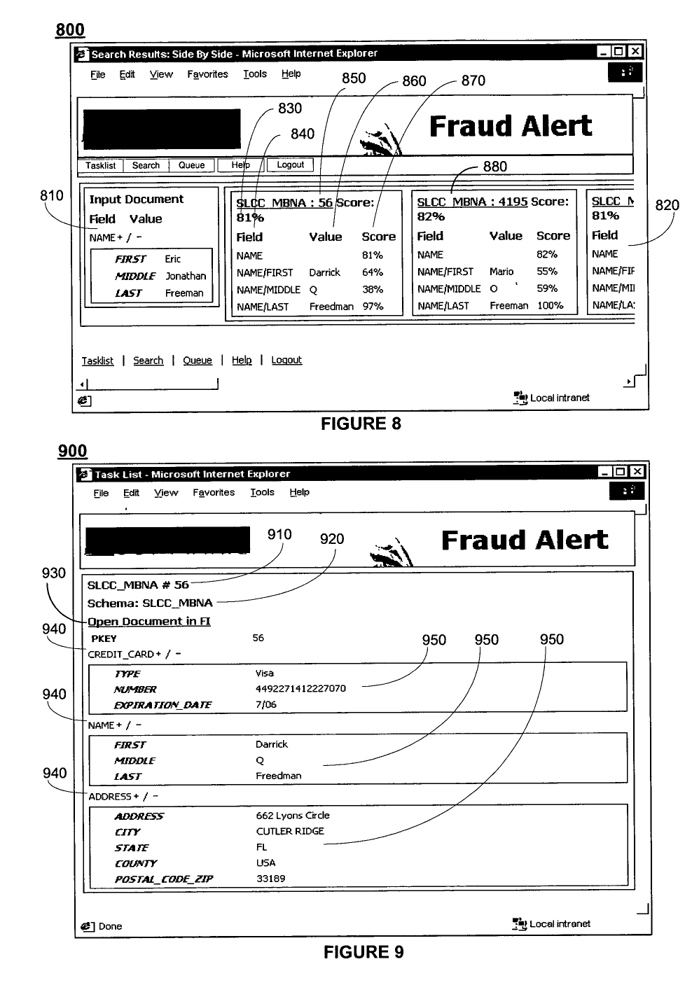

Turning to FIG. 8, FIG. 8 shows a screenshot 800 that allows a user to view details of multiple documents in a side-by-side fashion. The screenshot 800 displays two primary sections, a query document 810 for the side-by-side comparison and a detail table of search results 820 showing field-level data. The query document section 810 displays the field name 840, criteria value 860, and score 870 for each populated node in the query document. Unpopulated nodes are omitted. The detail table of search results 820 displays a column for each returned document in the result set. Each column has a sub-table that displays the following: the document's Identification 850 linked to the document detail view for this document, the document's overall score 830, and the target schema that the document is in 880. Each mapped row in the target document shows a score for that node 870 and a target value for that node 860. The SideBySideHandler supports the screenshot shown in FIG. 8.

Turning to FIG. 9, FIG. 9 shows a screenshot 900 that allows a user to view details of a single document. The screenshot 900 displays a table with the following information about the selected document: a document identification 910, a document's schema name 920, a link to open the document in the Fraud Investigator application 930, and each field name 940 and the field value 950, if populated. All fields defined in the schema are displayed, even if the document does not contain a value for it. The screenshot 900 is opened in a new window for each document. The DocumentDetailHandler supports the screenshot shown in FIG. 9.

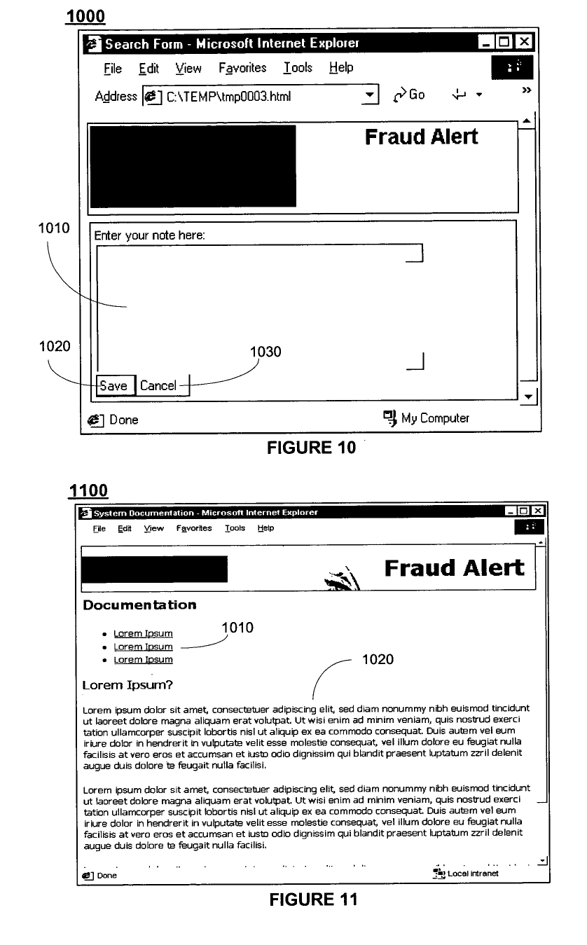

Turning now to FIG. 10, FIG. 10 shows a screenshot 1000 that enables a user to attach a note to a task record. The screenshot 1000 displays a text area 1010 to allow the user to enter a text/html note of up to 2000 characters. The screenshot 1000 displays a “Save” button 1020 and a “Cancel” button 1030. The screenshot 1000 appears as a pop-up window outside the window that created it. It does not display common navigation links in either the header or the footer, and does not display any screen specific navigation links in the header. A user is able to enter a note in free text or html in the form field 1010 of up to 2000 characters, and may also be able to press the “Save” button to save the note to the database. If a user presses the “Cancel” button, the window will close. If a user presses “Save” when the field is blank, the window will close and no note is saved. If a user enters text in the field, then presses “Cancel”, a confirmation dialog box appears asking: “Do you wish to save your changes? (Yes/No/Cancel)”. If yes, the note is saved, if no the note is discarded, and if cancel, the user is returned to the note form. When a user closes the window without pressing the “Cancel” or “Save” buttons, the changes will be lost. The NoteFormHandler supports the screenshot shown in FIG. 10.

Turning to FIG. 11, FIG. 11 shows a screenshot 1100 for enabling a user to view help information online. The screenshot 1100 displays the contents 1020 of the requested specific help topic 1010. If no specific topic is selected, the screenshot 1100 displays a table of contents for the entire help collection. The screen 1100 appears as a pop-up window outside the window that created it, and does not display the common navigation links in either the header or the footer. The screen 1100 also does not display any screen specific navigation links in the header. The HelpHandler supports the screenshot shown in FIG. 11.

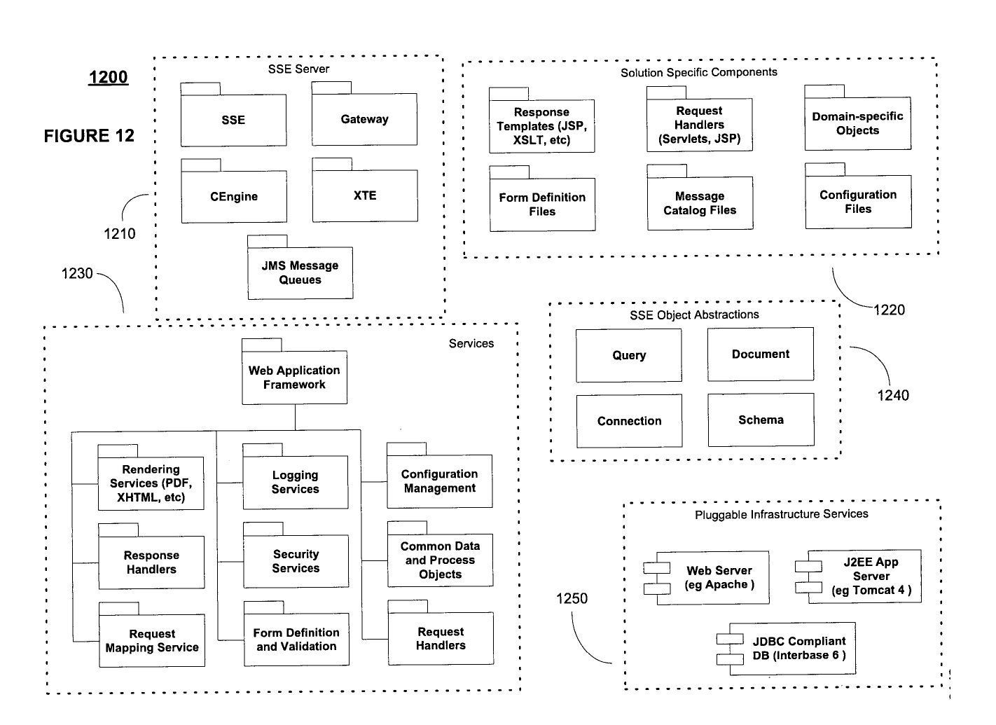

Turning now to FIG. 12, FIG. 12 shows a functional framework diagram 1200 of the components of the present invention. The components include an SSE Server 1210, Solution Specific Components 1220, Services 1230, SSE Object Abstractions 1240, and Pluggable Infrastructure Services 1250. The framework 1200 includes the following components: configuration management; standard schemas for solution configuration files, message catalogs, form definitions, page models, and stylesheets; service to handle automatic reloading of framework configuration; common request and response services; base set of javax.servlet.Filter classes to handle basic request and response services, such as logging, user authentication, error handling, and output rendering; base request and response handlers; request mapping servlet that will handle routing incoming requests to the appropriate request handler code; form class that will allow for easier definition, validation, parsing, and reloading of HTML input forms; set of reference servlets to process request objects and return XML data; set of reference servlets and JSPs to process XML data and create abstract page documents; common data and task objects; set of common objects and action handlers that will be used in most web based; and a subset of the custom API to ease interaction with the SSE.

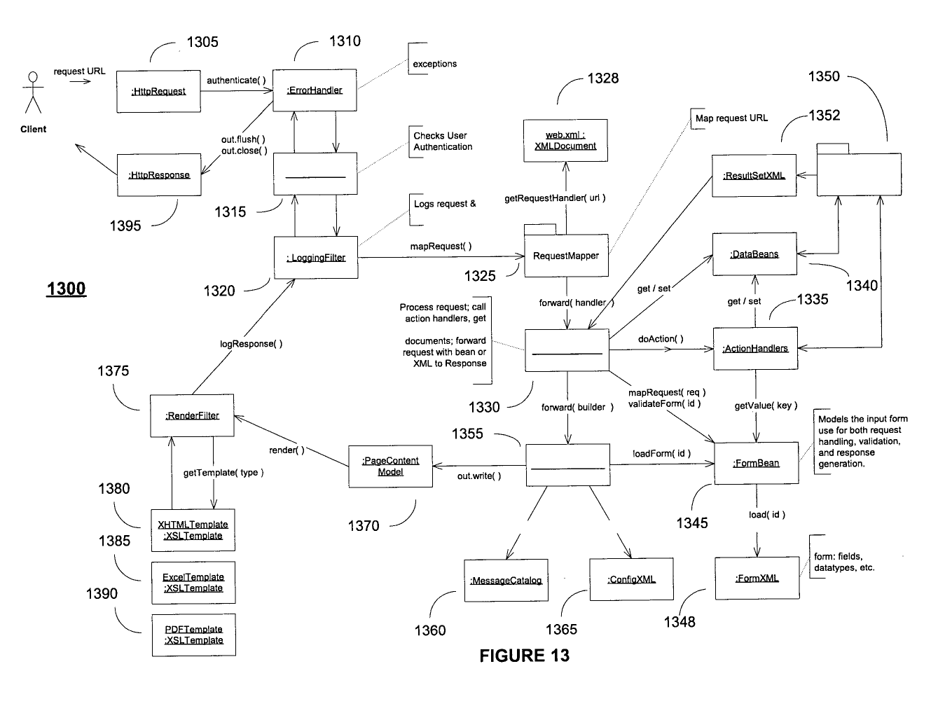

Turning to FIG. 13, FIG. 13 shows request handling flow diagram 1300 according to the present invention. The processing of a request begins with the generation of an HTML request 1305 in response to user inputs through the browser. The request is passed to the designated URL by way of an error handler 1310 set up to deal with uncaught exceptions. In the normal non-error flow, the request next passes through a security filter 1315 that verifies that the user is properly authenticated. Next, the request passes through a logging filter 1320 so that a persistent record of the request is made. Once the request has been authenticated and logged, it passed to a request mapper 1325, which invokes the appropriate request handler 1330 to carry out the requested action. The doAction( ) method is used to route the request to the appropriate action handlers 1335, drawing on DataBeans 1340 and FormBeans 1345 as well as entities in the SSE Object layer 1350 that perform searches and invoke external analytics. Action handlers 1335 include a login handler, a logout handler, a task handler, a detail handler, a task update handler, a search form handler, a search handler, a document detail handler, a side-by-side handler, a query queue handler, a query queue detail handler, and a note form handler. When the action handlers 1335 complete their operations, the request handler invokes the response builder 1355 to create the response to the request. The response builder 1355 also has access to the FormBeans 1345, as well as a message catalog 1360 and configuration files 1365. The response is written to the page content model 1370, which invokes the render filter 1375 to format the return HTML. For this it draws on XSL templates for XHTML 1380, Excel 1385, or PDF renderings 1390. The result takes the same path to client as the incoming request, except in reverse order: the response is logged 1320, authenticated by the security filter 1315, error-checked 1310 and finally transmitted back the user's browser 1395 via HTTP.

Although the present invention has been described in detail with reference to certain preferred embodiments, it should be apparent that modifications and adaptations to those embodiments might occur to persons skilled in the art without departing from the spirit and scope of the present invention.

What is claimed is:

1. A software implemented method in a computer system for browser-based arbitration in a classification workflow process, the method comprising the steps of:
authenticating a user name and password for enabling a user logon;
displaying a task list screen, the task list screen displaying a summary list containing each current task that the user has permission to view and links to a task detail screen, a search form screen, and a search queue screen; and
enabling the user to arbitrate an assigned classification of assigned tasks in the workflow process.

2. The method of claim 1, further comprising the step of allowing the user to update a
class, status and ownership of tasks selected from the summary list of each current task.

3. The method of claim 1, wherein the step of displaying the summary list of each current task includes the steps of:
displaying a link to a task details screen;
displaying a means for selecting the record;
displaying a source document identification;
displaying a task owner username;
displaying created time and date;
displaying a modified time and data;
displaying a task class;
displaying a task status; and
displaying a justification summary for a classification.

4. The method of claim 1, further comprising the step of linking to the task detail screen for displaying detailed information about the results of a task including the steps of displaying summary information, a task history/log, a summary of rule checks that were applied to a source document, and a summary of queries.

5. The method of claim 4 wherein the step of displaying summary information includes the steps of:
displaying a source document identification;
displaying a link to source document details screen;
displaying a task owner username;
displaying created time and date;
displaying a modified time and data;
displaying a current task class;
displaying a current task status;
displaying a justification summary for a classification; and
displaying means for enabling the user to update the task summary, the classification, and the owner.

6. The method of claim 4, wherein the step of displaying a task/history log includes the steps of:
displaying summary information from each entry in a task history and each note associated with the task;
displaying a button for enabling the user to create a new note;
displaying a date when a history record and each note was created; and
displaying a contents of a description field for a history record and each note.

7. The method of claim 4, wherein the step of displaying a summary of rule checks that were applied to a source document includes the steps of:
displaying a class for each rule;
displaying a description of each rule that was applied to the class;
displaying the target schema that was used in each rule check;
displaying a highest score from each rule check; and
displaying a link to a details screen for each rule check.

8. The method of claim 4, wherein the step of displaying a summary of queries includes the steps of:
displaying a name of a target schema;
displaying the name of a field mapping that was used to map an input schema to a target schema;
displaying a highest score returned;
displaying the number of documents that were returned; and
displaying a link to a side-by-side screen for displaying details of a query criteria and result.

9. The method of claim 1, further comprising the step of linking to the search form screen for enabling the user to define a query document and execute searches using available search engine schemas, comprising the steps of:
displaying text fields of a query document that match fields in a target schema for entering query data;
displaying one or more target schemas and means for selecting one or more target schemas to search against;
providing means for enabling the user to select immediate execution of a search and displaying a search results summary screen; and
providing means for enabling a user to select a search in background execution by sending the search criteria to a queue for later execution and displaying the task list screen.

10. The method of claim 9, further comprising the steps of:
displaying two text fields for enabling a user to enter a range of document indexes for restricting a result set;
displaying a means for selecting specific displayed schemas applicable to restricting a result set to a specific schema index ranges;
displaying two text fields for enabling a user to enter a range of document scores for restricting a result set; and
displaying a means for selecting specific displayed schemas applicable to restricting a result set to a specific score range.

11. The method of claim 1, further comprising the step of linking to the search queue screen for displaying status and results of background searches having delayed execution, comprising the steps of:
displaying a list of all searches queued by the user;
for each queued search, displaying means for selecting the queued search;
for each queued search, displaying a time/date that the search was queued and a time/date that the search was completed; and
for each queued search, displaying target schemas that were searched, a number of returned result documents, and a current status of the queued searches.

12. The method of claim 11, further comprising for each queued search, the step of displaying a link to a search results summary screen if a search is completed.

13. The method of claim 11, further comprising the step of displaying a means for deleting selected queued searches.

14 The method of claim 12, further comprising the step of linking to the search result summary screen for reviewing a result from a specific search, comprising the steps of:
displaying a field name and criteria value for each populated field in an original query document;
displaying summary search results for each returned document in a result set, including means for selecting a one or more result sets, result document identification for linking to a document detail search result screen, and result set score;
displaying a header label indicating a target schema and mapping used to generate a query;
displaying means for linking to a side-by-side search result screen and linking to a document detail search result screen; and
displaying means for selecting all documents in a result set and for clearing all documents in a result set.

15. The method of claim 14, further comprising the step of linking to the side-by-side search result screen for enabling the user to view details for multiple documents, comprising the steps of:
displaying query document data including field name, criteria value and score;
displaying side-by-side search results by column for each result set, including a document identification, overall document score, and target schema that contains the document; and
displaying a field name for each mapped node in a target schema, a target value for that node, and a score for that node.

16. The method of claim 14, further comprising the step of linking to the document detail search result screen for enabling the user to view results of a single document, comprising the steps of:
displaying a document identification, a document's schema name, and a link to open the document in a fraud investigator application; and
displaying each field name and field value of the result document.

17. The method of claim 1, further comprising the steps of;
enabling the user to attach a note to a task record; and
enabling the user to obtain help information online.

18. A computer-readable medium containing instructions for controlling a computer system according to the method of claim 1.

19. A user interface method for browser-based arbitration in a classification workflow process, the method comprising:
entering a user name and password for enabling user authentication;
viewing a task list screen, the task list screen displaying a summary list containing each current task that the user has permission to view and links to a task detail screen, a search form screen, and a search queue screen; and
arbitrating an assigned classification of assigned tasks in the workflow process.

20. The method of claim 19, further comprising updating a class, status and ownership of
tasks selected from the summary list of each current task.

21. The method of claim 19, further comprising viewing the summary list of each current task, including:
viewing a link to a task details screen;
viewing a means for selecting the record;
viewing a source document identification;
viewing a task owner username;
viewing created time and date;
viewing a modified time and data;
viewing a task class;
viewing a task status; and
viewing a justification summary for a classification.

22. The method of claim 19, further comprising selecting the task detail screen for viewing detailed information about the results of a task including viewing summary information, a task history/log, a summary of rule checks that were applied to a source document, and a summary of queries.

23. The method of claim 22, wherein viewing summary information includes:
viewing a source document identification;
viewing a link to source document details screen;
viewing a task owner username;
viewing created time and date;
viewing a modified time and data;
viewing a current task class;
viewing a current task status;
viewing a justification summary for a classification; and
viewing means for enabling the user to update the task summary, the classification, and the owner.

24. The method of claim 22, wherein viewing a task/history log includes:
viewing summary information from each entry in a task history and each note associated with the task;
viewing a button for enabling the user to create a new note;
viewing a date when a history record and each note was created; and
viewing a contents of a description field for a history record and each note.

25. The method of claim 22, wherein viewing a summary of rule checks that were applied to a source document includes:
viewing a class for each rule;
viewing a description of each rule that was applied to the class;
viewing the target schema that was used in each rule check;
viewing a highest score from each rule check; and
viewing a link to a details screen for each rule check.

26. The method of claim 22, wherein viewing a summary of queries includes:
viewing a name of a target schema;
viewing the name of a field mapping that was used to map an input schema to a target schema;
viewing a highest score returned;
viewing the number of documents that were returned; and
viewing a link to a side-by-side screen for displaying details of a query criteria and result.

27. The method of claim 19, further comprising selecting a link to the search form screen for enabling the user to define a query document and execute searches using available search engine schemas, comprising:
viewing text fields of a query document that match fields in a target schema for entering query data;
viewing one or more target schemas and means for selecting one or more target schemas to search against;
selecting immediate execution of a search and viewing a search results summary screen; and
selecting a search in background execution for sending the search criteria to a queue for later execution and viewing the task list screen.

28. The method of claim 27, further comprising:
entering a range of document indexes into two text fields for restricting a result set;
selecting specific displayed schemas applicable to restricting a result set to a specific schema index ranges;
entering a range of document scores into two text fields for restricting a result set; and
selecting specific displayed schemas applicable to restricting a result set to a specific score range.

29. The method of claim 19, further comprising selecting a link to the search queue screen for viewing status and results of background searches having delayed execution, comprising:
viewing a list of all searches queued by the user;
for each queued search, selecting one or more queued searches;
for each queued search, viewing a time/date that the search was queued and a time/date that the search was completed; and
for each queued search, viewing target schemas that were searched, a number of returned result documents, and a current status of the queued searches.

30. The method of claim 29, further comprising for each queued search, viewing a link to a search results summary screen if a search is completed.

31. The method of claim 29, further comprising viewing a means for deleting selected queued searches.

32 The method of claim 29, further comprising selecting the link to the search result summary screen for reviewing a result from a specific search, comprising the steps of:
viewing a field name and criteria value for each populated field in an original query document;
viewing summary search results for each returned document in a result set, including selecting a one or more result sets, result document identification for linking to a document detail search result screen, and result set score;
viewing a header label indicating a target schema and mapping used to generate a query;
linking to a side-by-side search result screen and linking to a document detail search result screen; and
selecting all documents in a result set and for clearing all documents in a result set.

33. The method of claim 32, further comprising selecting the link to the side-by-side search result screen for enabling the user to view details fo multiple documents, comprising:
viewing query document data including field name, criteria value and score;
viewing side-by-side search results by column for each result set, including a document identification, overall document score, and target schema that contains the document; and
viewing a field name for each mapped node in a target schema, a target value for that node, and a score for that node.

34. The method of claim 32, further comprising selecting the link to the document detail search result screen for enabling the user to view results of a single document, comprising:
viewing a document identification, a document's schema name, and a link to open the document in a fraud investigator application; and
viewing each field name and field value of the result document.

35. The method of claim 19, further comprising the steps of;
attaching a note to a task record; and
obtaining help information online.

36. A computer-readable medium containing instructions for controlling a computer system according to the method of claim 19.

37. A computer system for browser-based arbitration in a classification workflow process, comprising:
means for displaying workflow classification information;
means for initiating a search based on selected task information;
means for receiving task results from a classification engine; and
means for interactively classifying task results.

38. The system of claim 37, wherein the means for displaying and receiving is a computer display terminal, and the means for initiating and interactively classifying is a computer keyboard and mouse.

39. A method in a computer system for browser-based arbitration in a classification workflow process, comprising:
a user for entering, selecting, viewing and updating classification task information in the computer system; and
a computer display terminal, keyboard and mouse, and computer for displaying, enabling, linking, and providing classification task information to the user.
